(19) United States
(12) Patent Application Publication
(10) Pub. No.: US 2011/0018978 A1
(43) Pub. Date: Jan. 27, 2011

(54) 3D IMAGE DISPLAY APPARATUS AND 3D IMAGE DISPLAY METHOD

(75) Inventor: Shunta Ego, Kurokawa-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/839,584

(22) Filed: Jul. 20, 2010

(30) Foreign Application Priority Data
Jul. 21, 2009 (JP) 2009-170249
Apr. 19, 2010 (JP) 2010-095795
Jul. 8, 2010 (JP) 2010-155864

(51) Int. Cl. H04N 13/04

(52) U.S. Cl. 348/51; 348/E13.075

(57) ABSTRACT

Visibility at a time of stereoscopic viewing is improved by enabling parallax adjustment during shooting or reproduction of a moving image. A 3D image display apparatus includes a parallax adjustment control unit which performs parallax adjustment for the 3D image for stereoscopic viewing when receiving an instruction to perform the parallax adjustment via an interface such as a key pressing. The parallax adjustment control unit temporarily stops the 3D image for stereoscopic viewing that has being reproduced as a moving image on a display device and performs parallax adjustment. And then, the 3D image display apparatus resumes reproduction of the moving image in a manner which reflects a value obtained by the parallax adjustment.

### BACKGROUND OF THE INVENTION

1. Field of the Invention

The presently disclosed subject matter relates to a three-dimensional (3D) image display apparatus and a 3D image display method, and more particularly to technology that enhances stereoscopic visibility when reproducing a 3D moving image for stereoscopic viewing that has been imaged with a digital camera.

2. Description of the Related Art

In recent years, a digital stereoscopic camera has been developed in which a plurality of imaging devices are provided in a single camera to enable the camera to take a stereo image. Such a digital stereoscopic camera is configured to perform simultaneous shooting from different angles of the same object using the plurality of imaging devices, acquire a plurality of pieces of image data, for example, image data for a left eye and image data for a right eye, and generate 3D image data for stereoscopic viewing based on the acquired image data. Further, the camera is configured to display the image data on a display apparatus such as an LCD (Liquid Crystal Display) that is provided in the camera in a manner that the observer can see an image for a right eye and an image for a left eye with his/her right eye and left eye, respectively. Thereby, the observer can visually recognize the image data as a stereo image because of parallax for both eyes.

This kind of stereo image is not a truly 3D image, but is generated so as to appear 3D by means of parallax that is produced when two planar two-dimensional images are displayed in a shifted manner with respect to the left and right eyes. Adjustment of the parallax amount is difficult and, for example, if the parallax is made too large, stereoscopic viewing becomes impossible.

Therefore, technology relating to adjustment of a parallax amount when displaying a stereo image has been proposed.

For example, there is a known stereo image display apparatus which displays a stereo image based on a plurality of images that correspond to a plurality of viewing points The stereo image display apparatus is configured to calculate parallax amount adjustment information relating to adjustment of a parallax amount based on information relating to changes in a parallax amount, generate images for stereo display based on the parallax amount adjustment information, and interpolate a predetermined region in a plurality of images (for example, see Japanese Patent Application Laid-Open No. 2004-207772).

Further, for example, an apparatus is also known that is configured to acquire a user response to a stereo image that is displayed based on images taken from a plurality of viewing points each correspond to different parallaxes. The apparatus identifies a suitable parallax for the user based on the acquired response. Accordingly, when a stereo display is performed, the stereoscopic effect thereof can be adjusted by a simple operation (for example, see Japanese Patent Application Laid-Open No. 2004-7395).

### SUMMARY OF THE INVENTION

However, each of the conventional technologies described above relates to parallax adjustment for displaying a 3D still image. Consequently, there is the problem that, for example, stereoscopic viewing of 3D moving image becomes difficult because these apparatus cannot properly adjust parallax when there is a change in a distance between an object and the imaging apparatus (camera) during shooting or reproduction of a 3D moving image for stereoscopic viewing. However, in this respect, an apparatus that performs parallax adjustment during shooting of moving images or during reproduction of moving images has not been developed yet.

The presently disclosed subject matter has been made in view of the above circumstances, and an object of the invention is to provide a 3D image display apparatus and a 3D image display method that enable parallax adjustment during shooting or during reproduction of moving images that are 3D images for stereoscopic viewing, to thereby improve visibility at a time of stereoscopic viewing.

To achieve the above object, according to a first aspect of the presently disclosed subject matter, a 3D (three dimensional) image display apparatus, comprises: a display device which can display a 3D image for stereoscopic viewing including a plurality of images obtained by taking images of a same object from a plurality of viewing points; a reproduction key that instructs reproduction of the 3D image for stereoscopic viewing on the display device; a temporary stop key that instructs to temporarily stop the 3D image for stereoscopic viewing that is being reproduced as a moving image on the display device; a parallax adjustment key that instructs to perform parallax adjustment on the 3D image for stereoscopic viewing; and a parallax adjustment control unit that performs parallax adjustment on the 3D image for stereoscopic viewing according to an instruction from the parallax adjustment key, wherein the parallax adjustment control unit temporarily stops reproduction of the 3D image for stereoscopic viewing that is being reproduced as a moving image on the display device and performs parallax adjustment, and then resumes reproduction of the moving image with a parallax amount after the parallax adjustment reflected on the reproduction.

It is thus possible to perform parallax adjustment during moving image reproduction also, and to allow a user to check the stereoscopic view by resuming reproduction of the moving image with a parallax amount after the parallax adjustment reflected on the reproduction.

According to a second aspect of the presently disclosed subject matter, the 3D image display apparatus of the first aspect further comprises a storage apparatus that stores image data of the 3D image, wherein the display device is provided as a separate body from a control apparatus including the parallax adjustment control unit, and the storage apparatus.

Thus, the presently disclosed subject matter can also be applied to a 3D display apparatus that is not equipped with a parallax adjustment function.

Likewise, to achieve the above object, according to a third aspect of the presently disclosed subject matter, a 3D image display method comprises: when reproducing a 3D moving image for stereoscopic viewing on a display device that can display a 3D image for stereoscopic viewing, performing parallax adjustment upon receiving an input from a parallax adjustment key which instructs to adjust a parallax in a reproduction standby screen of the 3D moving image for stereoscopic viewing of the display device; reproducing the 3D moving image upon receiving an input from a reproduction key which instructs to reproduce the 3D moving image for stereoscopic viewing on the display device; temporarily stopping reproduction of the 3D moving image upon receiving an input from a temporary stop key during the reproduction of the 3D moving image; performing parallax adjustment on the 3D moving image upon receiving an input from the parallax adjustment key while the reproduction is temporarily stopped; and upon receiving an input from the reproduction key again, resuming reproduction of the moving image with a parallax amount after the parallax adjustment reflected on the reproduction.

It is thus possible to perform parallax adjustment during moving image reproduction also, and to allow the user to check the stereoscopic view by resuming reproduction of the moving image with a parallax amount after the parallax adjustment reflected on the reproduction.

According to a fourth aspect of the presently disclosed subject matter, when resuming reproduction of the moving image, the 3D moving image may be resumed from a time point at which reproduction of the 3D moving image has been temporarily stopped.

Further, according to a fifth aspect, when resuming reproduction of the moving image, the 3D moving image may be resumed from a beginning of the 3D moving image.

Thus, after parallax adjustment, reproduction of the moving image can be resumed and checked from an arbitrary time point.

Likewise, to achieve the above object, according to a sixth aspect of the presently disclosed subject matter, a 3D image display method comprises: when reproducing a 3D moving image for stereoscopic viewing on a display device that can display a 3D image for stereoscopic viewing, performing parallax adjustment upon receiving an input from a parallax adjustment key which instructs to adjust a parallax in a reproduction standby screen of the 3D moving image for stereoscopic viewing of the display device; reproducing the 3D moving image upon receiving an input from a reproduction key that instructs reproduction of the 3D moving image for stereoscopic viewing on the display device; temporarily stopping reproduction of the 3D moving image upon receiving an input from the parallax adjustment key during reproduction of the 3D moving image; performing parallax adjustment on the 3D moving image; and upon receiving an input from a stereoscopic display key or a reproduction key, or after a predetermined time period of a waiting state without a predetermined operation, resuming reproduction of the moving image with a parallax amount after the parallax adjustment reflected on the reproduction.

Thus, during reproduction of a moving image, it is possible to perform parallax adjustment without particularly requiring an input from a temporary stop key, and a user can check a stereoscopic view by resuming reproduction of the moving image with a parallax amount after the parallax adjustment reflected on the reproduction.

According to a seventh aspect of the presently disclosed subject matter, when resuming reproduction of the moving image, the 3D moving image may be resumed from a time point at which reproduction of the 3D moving image has been temporarily stopped.

Further, according to an eighth aspect, when resuming reproduction of the moving image, the 3D moving image may be resumed from a beginning of the 3D moving image.

Thus, after parallax adjustment, reproduction of the moving image can be resumed and checked from an arbitrary time point.

Likewise, to achieve the above object, according to a ninth aspect of the presently disclosed subject matter, a 3D image display method comprises: when reproducing a 3D moving image for stereoscopic viewing on a display device that can display a 3D image for stereoscopic viewing, performing parallax adjustment upon receiving an input from a parallax adjustment key which instructs to adjust a parallax in a reproduction standby screen of the 3D moving image for stereoscopic viewing of the display device; reproducing the 3D moving image upon receiving an input from a reproduction key that instructs reproduction of the 3D moving image for stereoscopic viewing on the display device; during reproduction of the 3D moving image, performing parallax adjustment on the 3D moving image upon receiving an input from the parallax adjustment key; and upon receiving an input from a stereoscopic display key or a reproduction key, or after a predetermined time period of a waiting state without a predetermined operation, resuming reproduction of the moving image with a parallax amount after the parallax adjustment reflected on the reproduction.

It is thus possible to perform parallax adjustment during moving image reproduction also, and to allow the user to check the stereoscopic view by resuming reproduction of the moving image with a parallax amount after the parallax adjustment reflected on the reproduction.

According to a tenth aspect of the presently disclosed subject matter, the 3D image display method according to any one of the third to ninth aspect, further comprises, when the parallax adjustment has been performed during reproduction of the 3D moving image, after reproduction of the 3D moving image ends, storing a parallax amount after the parallax adjustment automatically or after confirmation by a user.

According to an eleventh aspect of the presently disclosed subject matter, the 3D image display method according to the tenth aspect further comprises, when storing the parallax amount after the parallax adjustment, overwriting to update parallax adjustment information that is stored as tag information of a file that stores image data of the 3D moving image.

According to a twelfth aspect of the presently disclosed subject matter, the 3D image display method according to the tenth aspect further comprises: when storing the parallax amount after the parallax adjustment, creating a file which has contents identical to a file that stores image data of the 3D moving image and a file name different from the file; and rewriting parallax adjustment information that is stored as tag information of the created file.

It is thereby possible to store a parallax amount after the parallax adjustment that has been adjusted to a moving image while enabling the user to watch the moving image, and omit parallax adjustment when reproducing the moving image at subsequent times thereafter.

As described hereinbefore, according to the presently disclosed subject matter it is possible to perform parallax adjustment during moving image reproduction also, and to allow a user to check a stereoscopic view by resuming the moving image reproduction with parallax mount after the parallax adjustment reflected on the reproduction, and thus improve visibility during stereoscopic viewing.

### BRIEF DESCRIPTION OF THE DRAWINGS

FIG. 1 is a block diagram that illustrates an electrical configuration of a digital stereoscopic camera that includes a 3D image display apparatus as one embodiment of the presently disclosed subject matter;

FIG. 2 is an expanded block diagram of the operation unit that illustrates various keys provided in the operation unit;

FIG. 3 is a flowchart that illustrates a fundamental method for performing parallax adjustment in moving image reproduction;

FIG. 4 is a flowchart that illustrates a second example of parallax adjustment control;

FIG. 5 is a flowchart that illustrates a third example of parallax adjustment control;

FIG. 6 is a flowchart that illustrates a fourth example of parallax adjustment control;

FIG. 7 is a flowchart that illustrates a fifth example of parallax adjustment control;

FIG. 8 is a flowchart that illustrates a sixth example of parallax adjustment control;

FIG. 9 is a flowchart that illustrates a seventh example of parallax adjustment control; and

FIG. 10 is a flowchart that illustrates an eighth example of parallax adjustment control.

### DETAILED DESCRIPTION OF THE PREFERRED EMBODIMENTS

Hereinafter, a 3D image display apparatus and a 3D image display method according to the presently disclosed subject matter will be described in detail with reference to the accompanying drawings.

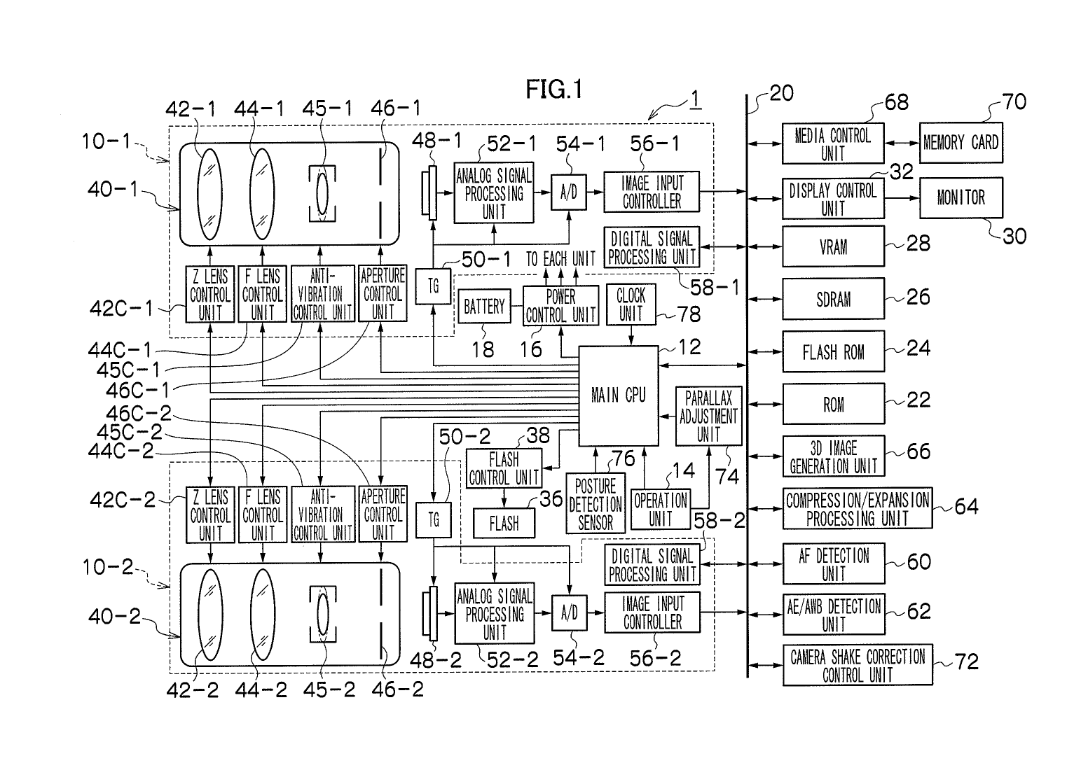

FIG. 1 is a block diagram that illustrates the electrical configuration of a digital stereoscopic camera that includes a 3D image display apparatus as one embodiment of the presently disclosed subject matter. As shown in FIG. 1, a digital stereoscopic camera 1 includes a plurality of imaging units (for the left eye and for the right eye) 10-1 and 10-2. The digital stereoscopic camera 1 acquires a parallax image which is obtained by shooting the identical object from a plurality of viewing points, and records the parallax image as image data for recording that is in a predetermined format.

Although according to the present embodiment the digital stereoscopic camera 1 includes a plurality of imaging units 10-1 and 10-2 for the left eye and for the right eye, it should be understood that a digital stereoscopic camera is not limited to a camera that has a plurality of imaging devices, and the manner in which an image for a left eye and an image for a right eye for generating a 3D image are acquired is not particularly limited.

For example, a plurality of captured images (moving images) of the same object that are imaged from a plurality of viewing points by a plurality of single-lens cameras may be used, or it is possible to generate a 3D image by combining captured images (moving images) obtained by shooting the same object with one single-lens camera multiple times from a plurality of different viewing points.

The following embodiment is described on the assumption that the digital stereoscopic camera 1 includes a plurality of imaging units (for the left eye and for the right eye) 10-1 and 10-2 as shown in FIG. 1.

A main CPU (Central Processing Unit) 12 (hereunder, referred to simply as “CPU 12”) functions as a control device which controls the entire operations of the digital stereoscopic camera 1 in accordance with a predetermined control program based on inputs from an operation unit 14. A power control unit 16 controls a power supply from a battery 18, and supplies operating power to each part of the digital stereoscopic camera 1.

A ROM (Read Only Memory) 22, a flash ROM 24, a SDRAM (Synchronous Dynamic Random Access Memory) 26, and a VRAM (Video RAM) 28 are connected via a bus 20 to the CPU 12. A control program that the CPU 12 executes and various data required for control and the like are stored in the ROM 22. Various kinds of setting information relating to operation of the digital stereoscopic camera 1 such as user settings information are stored in the flash ROM 24.

The SDRAM 26 includes a computation area for the CPU 12 and a temporary storage region (working memory) for image data. The VRAM 28 includes a temporary storage region dedicated to image data for display.

A monitor 30 is connected via a display control unit 32 to the bus 20. The monitor 30 comprises, for example, a display apparatus such as a color liquid-crystal panel, and is used as an image display unit for displaying a captured image, and also as a GUI (graphical user interface) when performing various settings. Furthermore, the monitor 30 is used as an electronic finder for confirming a field angle in a shooting mode. A so-called lenticular lens is disposed on the surface of the monitor 30. The lenticular lens has a group of semi-cylindrical lenses, and allows a user to view a 3D image stereoscopically when that image is displayed. The display control unit 32 converts image data read from image sensors 48 (48-1, 48-2) or a memory card 70 to image signals for display (for example, video signals such as NTSC (National Television System Committee) signals, or digital signals that are compatible with the monitor), and outputs the image signals to the monitor 30. The display control unit 32 also outputs predetermined characters and graphic information (for example, on-screen display data (OSD)) to the monitor 30. In addition, the display control unit 32 can output an image to an external display apparatus that is connected via a predetermined interface (for example, USB (Universal Serial Bus), IEEE 1394 (a standard of bus interface), or LAN (Lacal Area Network)).

The operation unit 14 includes operation input devices such as a shutter button, a power/mode switch, a mode dial, cross buttons, a zoom button, a MENU/OK button, a DISP button, and a BACK button. In this connection, keys and buttons other than the aforementioned are described later.

The power/mode switch functions as a device for switching the power of the digital stereoscopic camera 1 on and off, and as a device for switching between the operating modes (reproduction mode and shooting mode) of the digital stereoscopic camera 1.

The mode dial is an operation device for switching shooting modes of the digital stereoscopic camera 1. In accordance with the setting position of the mode dial, the shooting mode is switched between a 2D still-image shooting mode in which a two-dimensional still image is imaged, a 2D moving-image shooting mode in which a two-dimensional moving image is imaged, a 3D still-image shooting mode in which a 3D still image is imaged, and a 3D moving-image shooting mode in which a 3D moving image is imaged.

The shutter button comprises a two-step stroke-type switch that can be subjected to so-called “half press” and “full press” operations. In a still image shooting mode, when the shutter button is pressed halfway, shooting preparation processing (i.e., AE [Automatic Exposure], AF [Automatic Focusing], and AWB [Automatic White Balancing]) is performed, and when the shutter button is fully pressed, processing for shooting and recording an image is performed.

Further, in a moving image shooting mode, when the shutter button is fully pressed, shooting of a moving image is started, and when the shutter button is fully pressed again, the shooting ends. It is also possible to configure the settings so that shooting of a moving image is performed only while the shutter button is being fully pressed, and the shooting is ended when the full pressing of the shutter button is released.

The cross buttons are provided in a manner that they can be pressed in four directions: upward, downward, rightward and leftward. The button in each direction is assigned with a function that corresponds to an operating mode of the digital stereoscopic camera 1 or the like. For example, in a shooting mode, the left-side button is assigned with a function to switch a macro function on or off, and the right-side button is assigned with a function to switch flash modes. Also, in a shooting mode, the up button is assigned with a function to change the brightness of the monitor 30, and the down button is assigned with a function to switch a self timer on or off. In a reproduction mode, the left-side button is assigned with a frame advance function (frame by frame advance), and the right-side button is assigned with a frame return (frame by frame return) function. Further, in a reproduction mode, the up button is assigned with a function to change the brightness of the monitor 30, and the down button is assigned with a function to erase the image that is being reproduced. Furthermore, when performing various settings, the buttons are assigned with a function to move a cursor displayed on the monitor 30 in the direction of the relevant button.

The zoom button is an operation device for performing a zooming operation of the imaging units 10-1 and 10-2. The zoom button includes a zoom tele button for instructing zooming to a telescopic view side, and a zoom wide button for instructing zooming to a wider angle.

The MENU/OK button is used to cause the monitor 30 to display a menu screen (menu function), and is also used to confirm the selected contents, issue an instruction to execute processing (OK function) and the like. The assigned function of the MENU/OK button is switched according to the setting state of the digital stereoscopic camera 1. On the menu screen, the MENU/OK button performs the settings for all of the adjustment items of the digital stereoscopic camera 1, including, for example, image quality adjustments such as the exposure value, the color shade, the photographic sensitivity, the recording pixel count, the self timer setting, switching of a photometric method, and whether or not digital zooming is used. The digital stereoscopic camera 1 operates according to the conditions set on this menu screen.

The DISP button is used to input an instruction for switching the contents displayed on the monitor 30 or the like. The BACK button is used to input an instruction for cancelling an input operation or the like.

In addition to the keys and buttons described above, the operation unit 14 also includes keys (buttons) relating to camera control such as instructions for reproducing a moving image and performing parallax adjustment. These keys (buttons) are described later.

A flash (flash emitting unit) 36 is connected via a flash control unit 38 to the CPU 12. The flash 36 comprises, for example, a discharge tube (xenon tube), and emits light if needed when taking images of a dark object or a backlit object or the like. The flash control unit 38 includes a main condenser for supplying current to the flash 36 to cause the flash 36 to emit light, and controls the battery charge for the main condenser, the timing for discharge (light emitting) and the discharge time of the flash 36 and the like according to a flash light emitting instruction from the CPU 12.

Next, the shooting function of the digital stereoscopic camera 1 is described. An imaging unit 10 includes an imaging unit for the left eye 10-1 and an imaging unit for the right eye 10-2. Since the imaging unit for the left eye 10-1 and the imaging unit for the right eye 10-2 have the same configuration, in the following description the same reference numerals are used to designate common components of the imaging unit for the left eye 10-1 and the imaging unit for the right eye 10-2. As shown in FIG. 1, the branch number “−1” is assigned to components belonging to the imaging unit for the left eye 10-1 and the branch number “−2” is assigned to components belonging to the imaging unit for the right eye 10-2. For example, the imaging unit 10 includes taking lenses 40, and of these, the imaging unit for the left eye 10-1 includes a taking lens 40-1 and the imaging unit for the right eye 10-2 includes a taking lens 40-2. The following description of the imaging unit 10 is based on this assumption.

The imaging unit 10 includes a taking lens 40. The taking lens 40 includes a zoom lens 42, a focus lens 44, an anti-vibration lens 45, and an aperture 46. The imaging unit 10 also includes a zoom lens control unit (Z lens control unit) 42C, a focus lens control unit (F lens control unit) 44C, an anti-vibration lens control unit (anti-vibration control unit) 45C, an aperture control unit 46C, an image sensor 48, a timing generator (TG) 50, an analog signal processing unit 52, an A/D converter 54, an image input controller 56, and a digital signal processing unit 58.

The zoom lens 42 moves forward and backward along the optical axis by being driven by a zoom actuator that is not shown in the drawings. The CPU 12 controls the position of the zoom lens 42 to perform zooming, by controlling the driving of the zoom actuator via the zoom lens control unit 42C.

The focus lens 44 moves forward and backward along the optical axis by being driven by a focus actuator that is not shown in the drawings. Via the focus lens control unit 44C, the CPU 12 controls the position of the focus lens 44 to perform focusing, and also adjusts angles (angles of convergence) formed between the taking lens 40-1 and the taking lens 40-2 and the respective optical axes.

The aperture 46 comprises, for example, an iris aperture, and operates by being driven by an aperture actuator that is not shown in the drawings. The CPU 12 controls the opening amount (aperture value) of the aperture 46 to control the amount of light entering the image sensor 48 by controlling the driving of the aperture actuator via the aperture control unit 46C.

The CPU 12 synchronously drives the taking lenses 40-1 and 40-2 of the respective imaging units. More specifically, the focuses of the taking lenses 40-1 and 40-2 are adjusted so that they are set to always have the same focal length (zoom magnification), and always come into focus on the same object. Further, the apertures are adjusted so as to always have the same incident light amount (aperture value).

The image sensor 48 is, for example, a color CCD solid-state image sensor. Multiple photodiodes are two-dimensionally arranged on the light receiving surface of the image sensor (CCD) 48. Color filters are disposed in a predetermined arrangement on each photodiode. An optical image of an object that is formed on the light receiving surface of the CCD via the taking lens 40 is converted by the photodiodes into signal charges that are in accordance with the amount of incident light. The signal charges accumulated in the respective photodiodes are sequentially read from the image sensor 48 as voltage signals (image signals) according to the signal charges based on drive pulses applied by the TG 50 according to an instruction from the CPU 12. The image sensor 48 includes an electronic shutter function, and the exposure time period (shutter speed) is controlled by controlling the period of time during which charges are accumulated in the photodiodes.

In the present embodiment, a CCD is used as the image sensor 48, but an image sensor with another configuration, such as a CMOS sensor, can also be used.

The analog signal processing unit 52 includes a correlated double sampling circuit (CDS) for removing reset noises (low frequency waves) contained in an image signal output from the image sensor 48, and an AGC circuit for amplifying an image signal to control the image signal to a magnitude of a certain level. The analog signal processing unit 52 subjects an image signal output from the image sensor 48 to correlated double sampling processing and also amplification.

The A/D converter 54 converts an analog image signal output from the analog signal processing unit 52 into a digital image signal.

The image input controller 56 loads the image signal output from the A/D converter 54 and stores the signal in the SDRAM 26.

The digital signal processing unit 58 functions as an image processing device that includes a synchronization circuit (a processing circuit that interpolates spatial deviations of each color signal that accompany a color filter arrangement on a single-plate CCD to match the phases of the color signals), a white balance adjustment circuit, a gradation conversion processing circuit (for example, a gamma correction circuit), a contour correction circuit, and a luminance and color difference signal generation circuit, and performs predetermined signal processing on R, G and B image signals stored in the SDRAM 26. That is, the R, G and B image signals are converted into a YC signal consisting of a luminance signal (Y signal) and color difference signals (Cr and Cb signals) in the digital signal processing unit 58, and predetermined signal processing is performed on the signal. The image data processed by the digital signal processing unit 58 is stored in the VRAM 28.

When a captured image is output to the monitor 30, the image data is read from the VRAM 28 and sent to the display control unit 32 via the bus 20. The display control unit 32 converts the input image data into video signals in a predetermined format for display, and outputs the video signals to the monitor 30.

In addition to the above components, an AF detection unit 60, an AE/AWB detection unit 62, a compression/expansion processing unit 64, a 3D image generation unit 66, a media control unit 68, and a camera shake correction control unit 72 are also connected via the bus 20 to the CPU 12. A memory card 70 is connected to the media control unit 68. Further, a parallax adjustment unit 74, a posture detection sensor 76, and a clock unit 78 are connected to the CPU 12.

The AF detection unit 60 loads image signals for the respective colors R, G and B that are loaded from any one of image input controllers 56-1 and 56-2, and calculates a focal point evaluation value necessary for AF control. The AF detection unit 60 includes a high-pass filter that allows only high-frequency components of a G signal to pass through, an absolute value setting processing unit, a focus area extraction unit that clips out signals in a predetermined focus area set on the screen, and an integration unit that adds up absolute value data inside the focus area. The AF detection unit 60 outputs the absolute value data in the focus area that has been added up by the integration unit to the CPU 12 as the focal point evaluation value.

During AF control, the CPU 12 searches for a position at which the focal point evaluation value that is output from the AF detection unit 60 becomes local maximum, and moves the focus lens 44 to that position to thereby perform focusing on the object (main object). More specifically, during AF control, the CPU 12 first moves the focus lens 44 from a close range to infinity, and in the course of that movement, sequentially acquires focal point evaluation values from the AF detection unit 60 and detects the position where the focal point evaluation value becomes local maximum. Subsequently, the CPU 12 determines that the detected position where the focal point evaluation value becomes local maximum is a focused position, and moves the focus lens 44 to that position. As a result, the object positioned at the focus area (the main object) is focused on.

When shooting an object, focus adjustment of the focus lenses 44-1 and 44-2 of the taking lenses 40-1 and 40-2, and adjustment of the angle of convergence of the two taking lenses 40-1 and 40-2 is performed. At this time, the angle of convergence is small when looking at a faraway object and the angle of convergence is large when looking at a close object. If an object at close range is shot (photographed) in a state in which the angle of convergence is small, deviation between the object in the left and right images becomes large, and thus, it causes problems such as difficulty in vivid stereoscopic viewing and eye strain of a person viewing the image.

Consequently, it is preferable to adjust the angle of convergence according to the distance to the object so that the angle of convergence is made larger when shooting an object at close range and is made smaller when shooting an object at long range. Methods of adjusting the angle of convergence in this manner include a method in which the optical axes of the taking lenses 40-1 and 40-2 are adjusted so as to approximately intersect on the object (main object) at the shooting distance.

The AE/AWB detection unit 62 loads image signals of respective colors R, G and B that are loaded from any one of the image input controllers 56-1 and 56-2, and calculates an integration value necessary for AE control and AWB control. More specifically, the AE/AWB detection unit 62 divides one screen into a plurality of areas (for example, 8×8=64 areas), and calculates an integration value of the R, G and B signals for each of the divided areas.

During AE control, the CPU 12 acquires an integration value of the R, G and B signals for each area that has been calculated by the AE/AWB detection unit 62, calculates the brightness (photometric value) of the object, and sets the exposure for acquiring an appropriate exposure amount. More specifically, the CPU 12 sets the photographic sensitivity, the aperture value, the shutter speed, and whether or not flash light-emission is necessary.

Further, during AWB control, the CPU 12 inputs the integration value of the R, G and B signals for each area, which has been calculated by the AE/AWB detection unit 62, into the digital signal processing unit 58. The digital signal processing unit 58 calculates a gain value for white balance adjustment based on the integration value calculated by the AE/AWB detection unit 62. In addition, the digital signal processing unit 58 detects a type of light source based on the integration value calculated by the AE/AWB detection unit 62.

The compression/expansion processing unit 64 performs compression processing on input image data according to an instruction from the CPU 12 to generate compressed image data in a predetermined format. For example, compression processing that conforms to the JPEG (Joint Photographic Experts) standards is performed on a still image, while compression processing that conforms to the MPEG2, MPEG4 (Moving Picture Experts) or H.264 standard is performed on a moving image. In addition, the compression/expansion processing unit 64 performs expansion processing on input compressed image data according to an instruction from the CPU 12 to generate uncompressed image data.

The 3D image generation unit 66 generates a stereo image (3D image) from an image for a left eye and an image for a right eye that have been captured by the two taking lenses 40-1 and 40-2.

A media control unit 68 controls the reading/writing of data from/to the memory card 70 according to an instruction from the CPU 12.

The camera shake correction control unit 72 detects camera shake from a position of the camera that is detected by the posture detection sensor 76, and controls the anti-vibration lens control unit 45C to correct the camera shake.

The parallax adjustment unit 74 adjusts a parallax between an image for the left eye and an image for the right eye so that a stereo image displayed on the monitor 30 is stereoscopically viewed in a favorable manner when capturing an image or reproducing an image. The parallax adjustment is performed by changing the relative positions in the horizontal direction of the image for the left eye and the image for the right eye. The fundamental parallax control is described later.

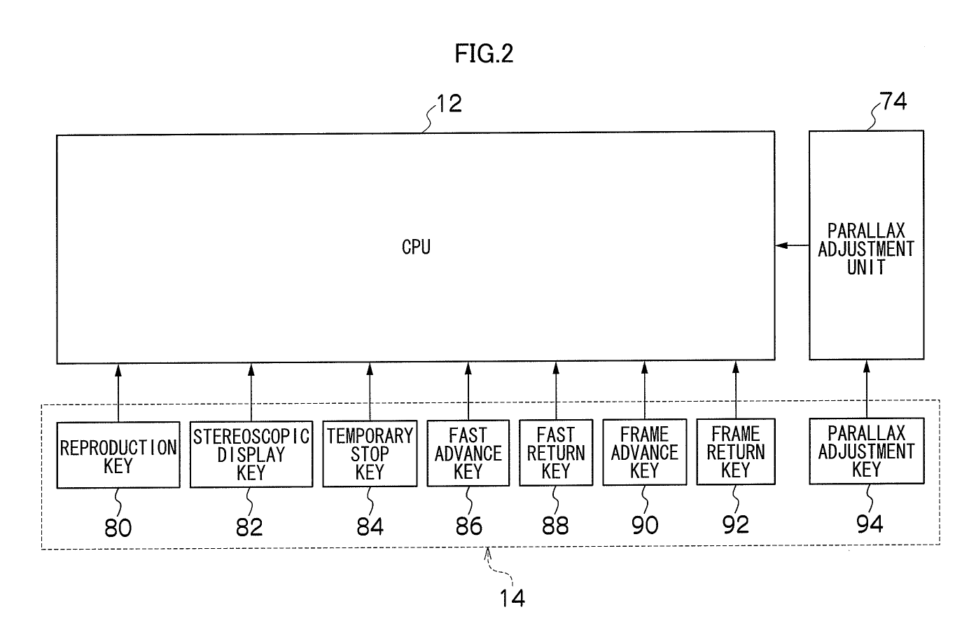

FIG. 2 is an expanded view of the operation unit 14, and shows keys other than the various buttons (switches) described above.

As shown in FIG. 2, in addition to the buttons described above, various keys such as a reproduction key 80, a stereoscopic display key 82, a temporary stop key 84, a fast advance key 86, a fast return key 88, a frame advance key 90, a frame return key 92, and a parallax adjustment key 94 are provided on the operation unit 14.

The reproduction key 80 is used by the user to input an instruction to reproduce a 2D or 3D image on the monitor 30 (display device). The stereoscopic display key 82 is used to input an instruction to, in particular, display a 3D image as an image for stereoscopic viewing on the monitor 30. The temporary stop key 84 is used to input an instruction to temporarily stop reproduction of a moving image. The fast advance key 86, fast return key 88, frame advance key 90, and frame return key 92 are used to input an instruction to perform reproduction using fast advance, fast return, frame advance, and frame return, respectively. The parallax adjustment key 94 is used to input an instruction to perform parallax adjustment when parallax adjustment is necessary while the user is viewing an image during reproduction on the monitor 30.

Hereunder, specific kinds of control for parallax adjustment are described.

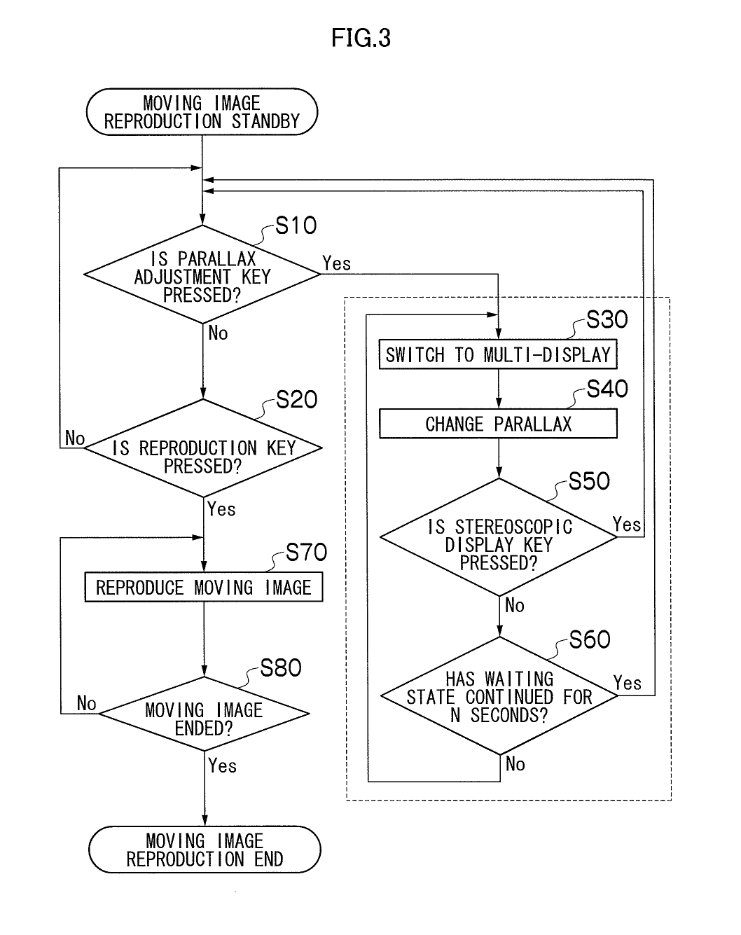

In a first example, control for parallax adjustment is performed with respect to fundamental moving image reproduction. FIG. 3 is a flowchart that illustrates a method of parallax adjustment when performing such fundamental moving image reproduction.

In step S10 in FIG. 3, the digital stereoscopic camera 1 accepts an input from the parallax adjustment key 94 while a 3D moving image reproduction standby screen is displayed on the monitor 30 thereof. More specifically, the digital stereoscopic camera 1 determines whether or not the parallax adjustment key 94 has been pressed.

If the parallax adjustment key 94 has not been pressed, in step S20 it is determined whether or not the reproduction key 80 has been pressed. If the reproduction key 80 has not been pressed, the operation returns to step S10.

In contrast, if it is determined in step S10 that the parallax adjustment key 94 has been pressed, the operation proceeds to step S30. In step S30, the screen display is switched to a multi-display that simultaneously displays two images comprising an image for a left eye and an image for a right eye. More specifically, at the time of parallax adjustment, the screen display changes to a multi-display that simultaneously displays two images comprising an image for a left eye and an image for a right eye.

Subsequently, in step S40, the parallax adjustment unit 74 changes the parallax. At this time, via the CPU 12, the parallax adjustment unit 74 moves one or both of the images for the left eye and for the right eye in the horizontal direction to adjust the parallax in a manner that the parallax amount between the image for the left eye and the image for the right eye becomes a value within a range of parallax amount that enables comfortable stereoscopic viewing. The range of parallax amount that enables comfortable stereoscopic viewing has already been studied, and it is known that stereoscopic viewing can not be performed if a parallax amount is too small or too large.

Next, in step S50, it is determined whether or not the stereoscopic display key 82 has been pressed. If the stereoscopic display key 82 has been pressed, the operation returns to step S10 to determine whether or not the parallax adjustment key 94 has been pressed. In contrast, if it is determined in step S50 that the stereoscopic display key 82 has not been pressed, in the subsequent step S60 it is determined whether or not a predetermined time period (N seconds) has elapsed with no operations inputted from a user to the digital stereoscopic camera 1. Hereinafter, a state where the digital stereoscopic camera 1 receives no operations inputted from a user is referred to as a “waiting state.” If N seconds has not elapsed, the process returns to step S30. In contrast, if N seconds has elapsed, the process returns to step S10.

The processing from step S30 to step S60 in the section surrounded by a broken line in FIG. 3 is referred to as “parallax adjustment” in the present specification. Accordingly, processing in a block called “parallax adjustment” in the flowcharts of a second example and a third example of parallax adjustment control described hereunder indicate the processing in the section surrounded by the broken line in FIG. 3.

In step S20, if it is determined that the reproduction key 80 has been pressed, the operation proceeds to step S70 to reproduce a moving image on the monitor 30. At this time, if the parallax adjustment key 94 has been pressed in step S10, parallax adjustment has been performed, and the moving image reproduction is performed using a parallax amount after the parallax adjustment. More specifically, the moving image reproduction in this case is performed using a single constant parallax amount that has been subjected to parallax adjustment from the beginning to the end of the reproduction.

Finally, in step S80, when it is determined that the moving image has ended, the digital stereoscopic camera 1 ends reproduction of the moving image.

According to this example, it is possible to perform parallax adjustment any number of times by pressing the parallax adjustment key 94 before reproduction of a moving image (when standing by for moving image reproduction), and not by using a parallax recorded in the moving image file. However, according to this example, only the first frame of the moving image can be utilized for parallax adjustment, and it is not possible to perform parallax adjustment during moving image reproduction or temporary stop of the moving image reproduction. Hereunder, an example is described in which this point is modified to allow parallax adjustment to be performed during moving image reproduction.

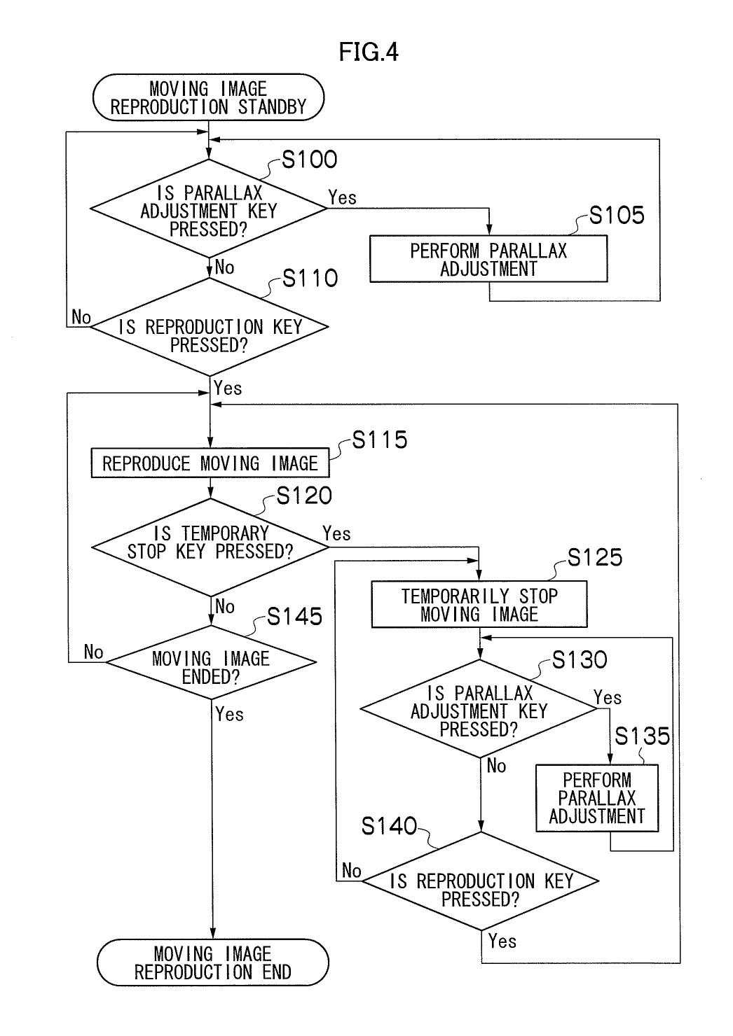

FIG. 4 illustrates a flowchart according to a second example of parallax adjustment control.

According to this example, a configuration is adopted in which moving image reproduction can be continued by using parallax that has been changed by performing parallax adjustment upon pressing a temporary stop key during moving image reproduction.

The processing from step S100 to step S115 in FIG. 4 is the same as the processing from step S10 to step S70 in FIG. 3. That is, in step S100 in FIG. 4, when on standby for 3D moving image reproduction, it is determined whether or not the parallax adjustment key 94 has been pressed. If the parallax adjustment key 94 has been pressed, parallax adjustment is performed in step S105. As described above, this parallax adjustment control is the same as the processing from step S30 to step S60 in FIG. 3. More specifically, the screen display switches to a multi-display that simultaneously displays two images comprising an image for a left eye and an image for a right eye, and the parallax is adjusted in a manner that the parallax amount between the images for the left eye and for the right eye becomes a value within a range of parallax amounts that enable comfortable stereoscopic viewing.

Further, in FIG. 4, if the parallax adjustment key 94 has not been pressed in step S100, in the subsequent step S110 it is determined whether or not the reproduction key 80 has been pressed.

In step S110, if the reproduction key 80 has not been pressed, the operation returns to step S100. In contrast, if the reproduction key 80 has been pressed, the process proceeds to step S115 to execute reproduction of a moving image. At this time, if the parallax adjustment key 94 has been pressed as described above, 3D moving image reproduction is performed using a parallax amount that has been changed by parallax adjustment.

Next, in step S120, it is determined whether or not the temporary stop key 84 has been pressed during moving image reproduction.

If the temporary stop key 84 has been pressed, in step S125 the moving image reproduction temporarily stops. Next, in step S130, it is determined whether or not the parallax adjustment key 94 is pressed. In this case, if the parallax adjustment key 94 has been pressed, the process proceeds to step S135 to perform parallax adjustment. This parallax adjustment control is also the same as the processing in step S30 to step S60 in FIG. 3. Further, in step S130, if it is determined that the parallax adjustment key 94 has not been pressed, the operation proceeds to step S140 to determine whether or not the reproduction key 80 has been pressed. If it is determined that the reproduction key 80 has been pressed, the operation returns to step S115 to resume moving image reproduction. In contrast, if it is determined that the reproduction key 80 has not been pressed, the operation returns to step S125 to continue the state in which reproduction of the moving image is temporarily stopped.

Next, in step S145, it is determined whether or not the moving image has ended. If it is determined that the moving image has not ended yet, the operation returns to step S115 to continue reproduction of the moving image. If it is determined that the moving image has ended, the digital stereoscopic camera 1 ends reproduction of the moving image.

Thus, according to this example, parallax adjustment can also be performed during moving image reproduction. More specifically, when moving image reproduction is temporarily stopped by means of the temporary stop key 84 during moving image reproduction and at that time the parallax adjustment key 94 is pressed, parallax adjustment is performed. Further, after the parallax adjustment ends, when the reproduction key 80 is pressed, reproduction of the moving image as a 3D image starts again switching from the screen on which the image for the left eye and the image for the right eye have been multi-displayed.

According to this example, in a case in which stereoscopic viewing becomes difficult during moving image reproduction due to a change in the distance between the object and the camera, the user can temporarily stop reproduction of the moving image and perform parallax adjustment using the frame that is being reproduced at that time.

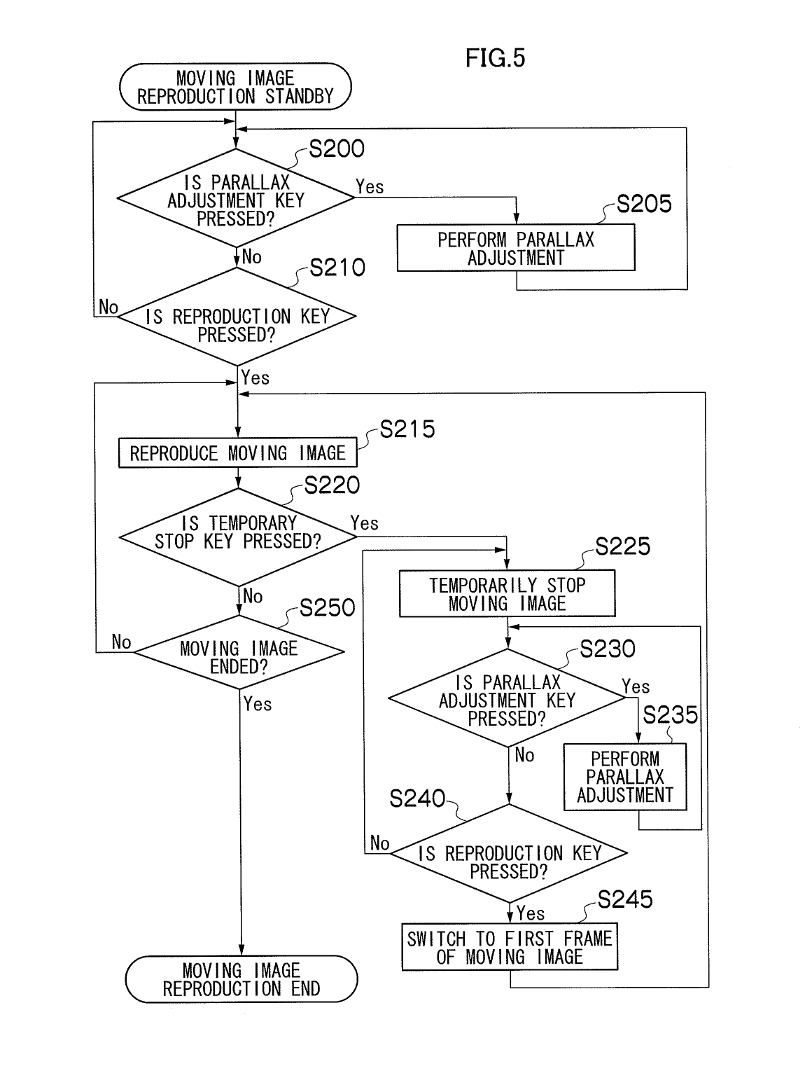

FIG. 5 illustrates a flowchart according to a third example of parallax adjustment control.

Although this example is approximately the same as the second example, according to this example a configuration is adopted such that when the reproduction key is pressed after temporarily stopping moving image reproduction and performing parallax adjustment, the moving image reproduction switches to the first frame of the moving image.

In step S200 in FIG. 5, when standing by for 3D moving image reproduction, it is determined whether or not the parallax adjustment key 94 has been pressed. If it is determined that the parallax adjustment key 94 has been pressed, the operation proceeds to step S205 to perform parallax adjustment. In contrast, if it is determined that the parallax adjustment key 94 has not been pressed, the process proceeds to step S210 to determine whether or not the reproduction key 80 has been pressed.

In step S210, if the reproduction key 80 has not been pressed, the operation returns to step S200. In contrast, if the reproduction key 80 has been pressed, the operation proceeds to step S215 to execute reproduction of a moving image. At the time of this moving image reproduction, if the parallax adjustment key 94 has been pressed as described above, 3D moving image reproduction is performed using a parallax amount that has been changed by the above parallax adjustment.

Next, in step S220, it is determined whether or not the temporary stop key 84 has been pressed during moving image reproduction.

In the temporary stop key 84 has been pressed, in step S225 the moving image reproduction is temporarily stopped. Next, in step S230, it is determined whether or not the parallax adjustment key 94 has been pressed. In this case, if the parallax adjustment key 94 has been pressed, the operation proceeds to step S235 to perform parallax adjustment. Further, in step S230, if it is determined that the parallax adjustment key 94 has not been pressed, the operation proceeds to step S240 to determine whether or not the reproduction key 80 has been pressed. If it is determined that the reproduction key 80 has been pressed, in step S245, the moving image reproduction switches to the first frame of the moving image, and the operation returns to step S215 to resume reproduction of the moving image. If it is determined in step S240 that the reproduction key 80 has not been pressed, the operation returns to step S225 to continue the temporarily stopped state of the moving image.

Next, in step S250, it is determined whether or not the moving image has ended. If it is determined that the moving image has not ended yet, the process returns to step S215 to continue reproduction of the moving image. If it is determined that the end of the moving image has been reached, the digital stereoscopic camera 1 ends reproduction of the moving image.

Thus, according to this example, the reproduction of a moving image is temporarily stopped, and at that time, it is possible to perform parallax adjustment. After the parallax adjustment, the reproduction is resumed from the first frame of the moving image, i.e., returning to the beginning of the moving image.

According to this example, when stereoscopic viewing becomes difficult during moving image reproduction due to a change in the distance between the object and the camera, the user can stop reproduction of the moving image and perform parallax adjustment using the frame that is being reproduced at that time. The user can then reproduce and check the moving image from the beginning using the value after the parallax adjustment.

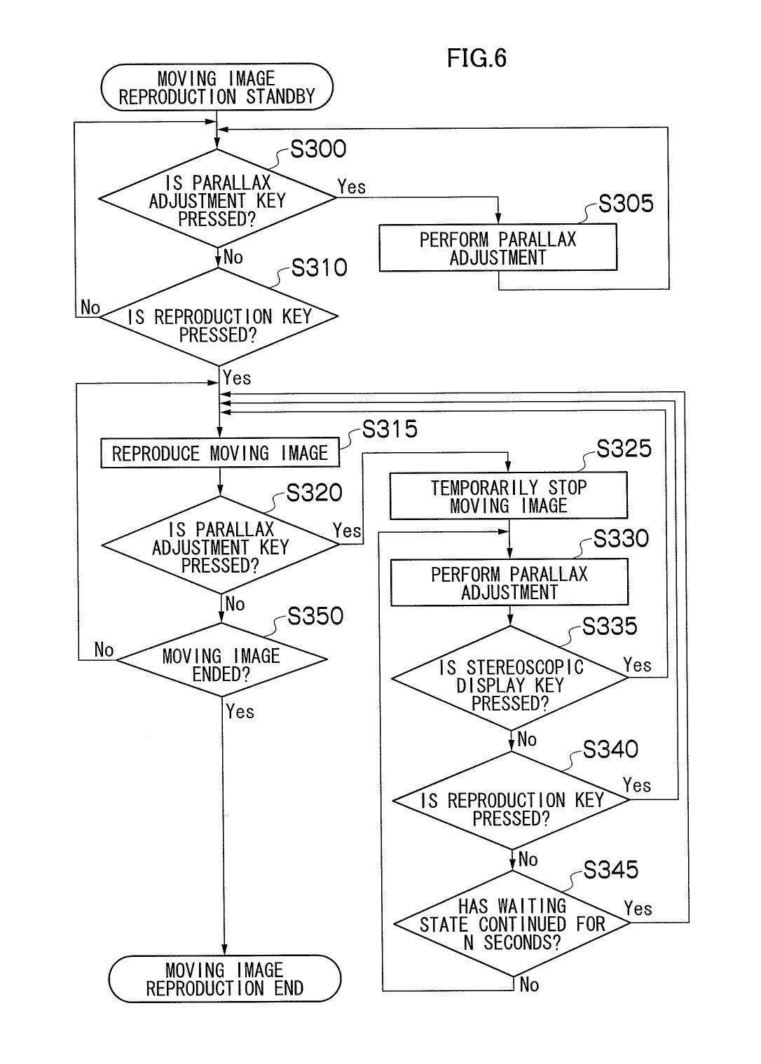

FIG. 6 illustrates a flowchart according to a fourth example of parallax adjustment control.

This example differs from the preceding examples in that, when the user wishes to perform parallax adjustment during moving image reproduction, by pressing the parallax adjustment key 94 and without pressing the temporary stop key 84, the moving image reproduction automatically stops temporarily to perform parallax adjustment.

In step S300 in FIG. 6, when standing by for 3D moving image reproduction, it is determined whether or not the parallax adjustment key 94 has been pressed. If it is determined that the parallax adjustment key 94 has been pressed, the process proceeds to step S305 to perform parallax adjustment. This parallax adjustment control is the same as the processing in step S30 to step S60 in FIG. 3.

In contrast, if it is determined that the parallax adjustment key 94 has not been pressed, the process proceeds to step S310 to determine whether or not the reproduction key 80 has been pressed.

In step S310, if the reproduction key 80 has not been pressed, the process returns to step S300. In contrast, if the reproduction key 80 has been pressed, the process proceeds to step S315 to execute reproduction of a moving image. At the time of this moving image reproduction, if the parallax adjustment key 94 has been pressed as described above, 3D moving image reproduction is performed using a parallax amount that has been changed by the parallax adjustment.

Next, in step S320, it is determined whether or not the parallax adjustment key 94 has been pressed during reproduction of the moving image.

If the parallax adjustment key 94 has been pressed, the process proceeds to step S325 to temporarily stop reproduction of the moving image. Next, in step S330, parallax adjustment is executed. Thus, according to the present example, when the parallax adjustment key 94 is pressed during moving image reproduction, the moving image is temporarily stopped and parallax adjustment is performed without operation of the temporary stop key 84.

In this connection, the parallax adjustment control in step S330 is control that performs processing to switch the screen display that has been temporarily stopped to a multi-display that simultaneously displays two images comprising an image for a left eye and an image for a right eye, and adjusts the parallax so that a parallax amount between the image for the left eye and the image for the right eye becomes a value within a range of parallax amounts that enable comfortable stereoscopic viewing.

Next, in step S335, it is determined whether or not the stereoscopic display key 82 has been pressed. If the stereoscopic display key 82 has been pressed, the process returns to step S315. In step S315, the multi-display is ended, and reproduction of the moving image as a stereo image is resumed. Further, if the stereoscopic display key 82 has not been pressed, the process proceeds to step S340 to determine whether or not the reproduction key 80 has been pressed.

In step S340, if it is determined that the reproduction key 80 has been pressed, the process returns to step S315. In step S315, the multi-display is ended and reproduction of the moving image as a stereo image is resumed. In contrast, if it is determined that the reproduction key 80 has not been pressed, the process proceeds to step S345. In step S345, it is determined whether or not a predetermined time period (N seconds) has elapsed with no operations inputted from the user to the digital stereoscopic camera 1. That is, it is determined whether a waiting state has continued for N seconds. In this case, if the waiting state has continued for N seconds, the process returns to step S315. In step S315, the multi-display is ended and reproduction of the moving image as a stereo image is resumed. In contrast, if N seconds has not yet elapsed since entering the waiting state, the process returns to step S330 to perform parallax adjustment.

If it is determined in step S320 that the parallax adjustment key 94 has not been pressed, the process proceeds to step S350. In step S350, it is determined whether or not the moving image has ended. If the moving image has not yet ended, the process returns to step S315 to continue reproduction of the moving image. If the moving image has ended, the digital stereoscopic camera 1 ends reproduction of the moving image.

Thus, according to the present example, when the parallax adjustment key 94 is pressed during moving image reproduction, the moving image reproduction stops temporarily and parallax adjustment is performed without the user's operation of the temporary stop key 84. Thus, in comparison to the examples described above, it is possible to perform parallax adjustment immediately during moving image reproduction without pressing the temporary stop key 84.

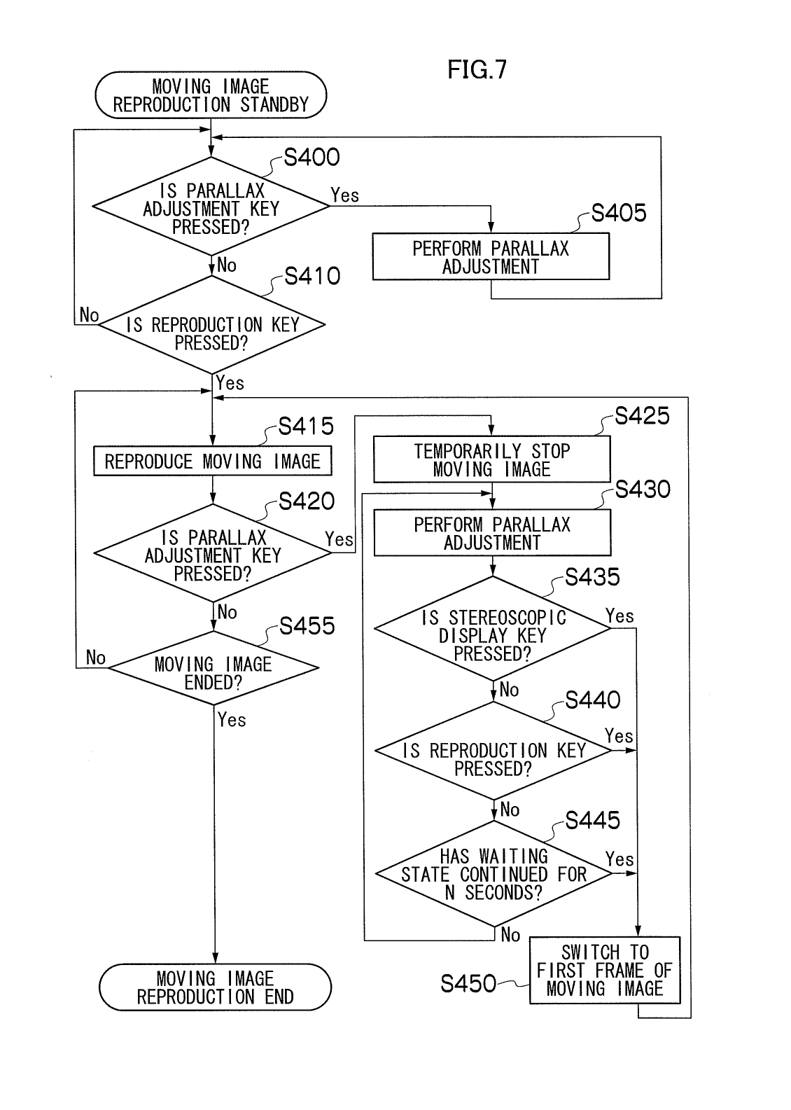

FIG. 7 is a flowchart that illustrates a fifth example of parallax adjustment control.

According to this example, similarly to the above fourth example, by pressing the parallax adjustment key 94 and without pressing the temporary stop key 84 when performing parallax adjustment during moving image reproduction, the moving image reproduction automatically stops temporarily to perform parallax adjustment. However, according to the present example, after performing parallax adjustment, reproduction of the moving image resumes from the beginning (first frame) of the moving image.

In step S400 in FIG. 7, when standing by for 3D moving image reproduction, it is determined whether or not the parallax adjustment key 94 has been pressed. If it is determined that the parallax adjustment key 94 has been pressed, the process proceeds to step S405 to perform parallax adjustment. This parallax adjustment control is the same as the processing in step S30 to step S60 in FIG. 3. In contrast, if it is determined that the parallax adjustment key 94 has not been pressed, the process proceeds to step S410 to determine whether or not the reproduction key 80 has been pressed.

In step S410, if the reproduction key 80 has not been pressed, the process returns to step S400. In contrast, if the reproduction key 80 has been pressed, the process proceeds to step S415 to execute reproduction of a moving image. At the time of this moving image reproduction, if the parallax adjustment key 94 has been pressed as described above, 3D moving image reproduction is performed using a parallax amount that has been changed by the parallax adjustment.

Next, in step S420, it is determined whether or not the parallax adjustment key 94 has been pressed during reproduction of the moving image.

If the parallax adjustment key 94 has been pressed, the process proceeds to step S425 to temporarily stop reproduction of the moving image. Next, in step S430, parallax adjustment is executed. Thus, according to the present example, similarly to the fourth example, when the parallax adjustment key 94 is pressed during moving image reproduction, the moving image is temporarily stopped and parallax adjustment is performed without the user's operation of the temporary stop key 84. In the parallax adjustment control in step S430, the screen displaying the moving image is switched to the multi-display screen in which two images comprising an image for a left eye and an image for a right eye are simultaneously displayed, and the parallax amount between the image for the left eye and the image for the right eye is adjusted to be a value within a range which enables comfortable stereoscopic viewing.

Next, in step S435, it is determined whether or not the stereoscopic display key 82 has been pressed. If the stereoscopic display key 82 has been pressed, the process proceeds to step S450. In step S450, the display is switched to the first frame of the moving image. Thereafter, the process returns to step S415 to again perform reproduction from the beginning of the moving image.

If the stereoscopic display key 82 has not been pressed in step S435, the process proceeds to step S440 to determine whether or not the reproduction key 80 has been pressed. In step S440, if it is determined that the reproduction key 80 has been pressed, the process proceeds to step S450 to switch the display to the first frame of the moving image. Thereafter, the process returns to step S415 to again perform reproduction from the beginning of the moving image.

If it is determined in step S440 that the reproduction key 80 has not been pressed, the process proceeds to step S445. In step S445, it is determined whether or not a predetermined time period (N seconds) has elapsed with no operations inputted to the digital stereoscopic camera 1. That is, it is determined whether a waiting state has continued for N seconds.

In this case, if the waiting state has continued for N seconds, the process returns to step S415. In step S415, reproduction of the moving image is resumed. In contrast, if N seconds has not yet elapsed since entering the waiting state, the process returns to step S430 to perform parallax adjustment.

Further, when it is determined in step S420 that the parallax adjustment key 94 has not been pressed, the process proceeds to step S455. In step S455, it is determined whether or not the moving image has ended. If the moving image has not yet ended, the process returns to step S415 to continue reproduction of the moving image. If the moving image has ended, the digital stereoscopic camera 1 ends reproduction of the moving image.

Thus, according to the present example, by pressing the parallax adjustment key 94 during moving image reproduction, it is possible to temporarily stop the moving image without a user's operation of the temporary stop key 84 and perform parallax adjustment. Further, since the display is switched to the first frame of the moving image thereafter, the user can check the moving image from the beginning using a value that has undergone parallax adjustment.

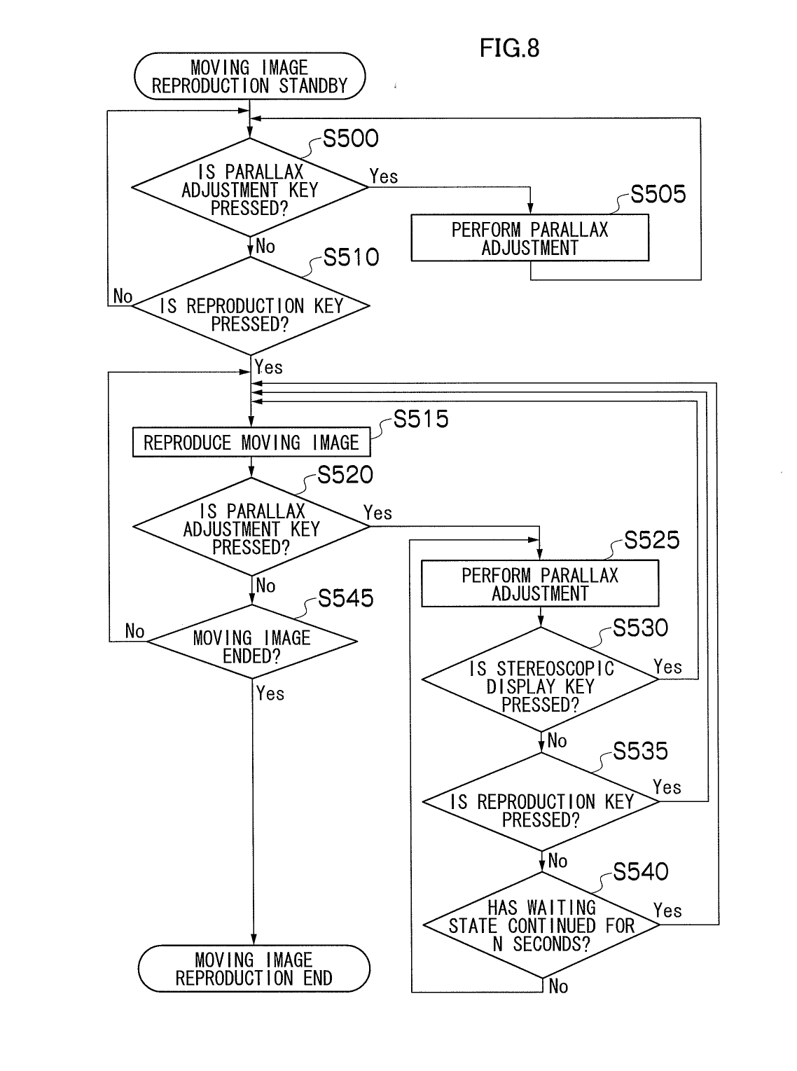

FIG. 8 illustrates a flowchart of a sixth example of parallax adjustment control.

This example differs to the respective examples described above in that, when performing parallax adjustment during moving image reproduction, parallax adjustment is executed while performing moving image reproduction without temporarily stopping reproduction of the moving image.

In step S500 in FIG. 8, when standing by for 3D moving image reproduction, it is determined whether or not the parallax adjustment key 94 has been pressed. If it is determined that the parallax adjustment key 94 has been pressed, the process proceeds to step S505 to perform parallax adjustment. This parallax adjustment control is the same as the processing in step S30 to step S60 in FIG. 3. In contrast, if it is determined that the parallax adjustment key 94 has not been pressed, the process proceeds to step S510 to determine whether or not the reproduction key 80 has been pressed.

In step S510, if the reproduction key 80 has not been pressed, the process returns to step S500. In contrast, if the reproduction key 80 has been pressed, the process proceeds to step S515 to execute reproduction of a moving image. At the time of this moving image reproduction, if the parallax adjustment key 94 has been pressed as described above, 3D moving image reproduction is performed using a parallax amount that has been changed by the parallax adjustment.

Next, in step S520, it is determined whether or not the parallax adjustment key 94 has been pressed during reproduction of the moving image.

If it is determined in step S520 that the parallax adjustment key 94 has been pressed, the process proceeds to step S525 to execute parallax adjustment. The parallax adjustment executed in step S525 is performed while reproducing the moving image. This parallax adjustment is performed by interposing a process in the other examples in which an image is temporarily stopped and an adjustment is performed with respect to a still image, into the reproduction of the moving image.

Further, a screen on which a moving image is reproduced as a stereo image is switched to a multi-display in which two images comprising an image for a left eye and an image for a right eye are simultaneously displayed, and the parallax adjustment is performed in a manner that a parallax amount between the image for the left eye and the image for the right eye becomes a value within a range that enables comfortable stereoscopic viewing.

Next, in step S530, it is determined whether or not the stereoscopic display key 82 has been pressed. If the stereoscopic display key 82 has been pressed, the process returns to step S515. In step S515, the screen is switched from the multi-display to the stereo image display, and reproduction of the moving image is resumed. If the stereoscopic display key 82 has not been pressed, the process proceeds to step S535 to determine whether or not the reproduction key 80 has been pressed.

If it is determined in step S535 that the reproduction key 80 has been pressed, the process returns to step S515. In step S515, the display is switched from a multi-display to a stereo image display, and reproduction of the moving image is resumed. In contrast, if it is determined that the reproduction key 80 has not been pressed, the process proceeds to step S540. In step S540, it is determined whether or not a waiting state of the digital stereoscopic camera 1 has continued for a predetermined N seconds.

In this case, if the waiting state has continued for N seconds, the process returns to step S515 to continue reproduction of the moving image. In contrast, if N seconds has not yet elapsed since entering the waiting state, the process returns to step S525 to perform parallax adjustment.

Further, if it is determined in step S520 that the parallax adjustment key 94 has not been pressed, the process proceeds to step S545. In step S545, it is determined whether or not the moving image has ended. If the moving image has not yet ended, the process returns to step S515 to switch from the multi-display to the stereo image display and resume moving image reproduction. In contrast, if it is determined that the moving image has ended, the digital stereoscopic camera 1 ends reproduction of the moving image.

Thus, according to the present example, it is possible to perform parallax adjustment while reproducing a moving image, and while the moving image is being reproduced the user can adjust the parallax while viewing the motion of the moving image.

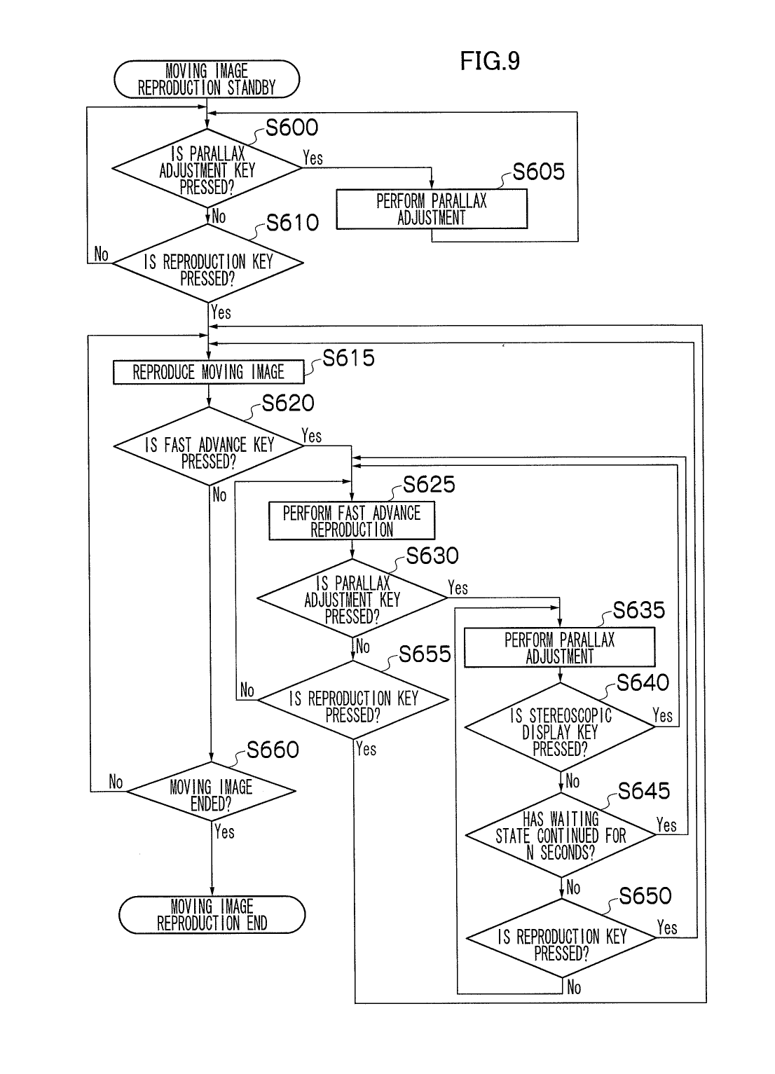

FIG. 9 illustrates a flowchart of a seventh example of parallax adjustment control.

This example enables parallax adjustment during fast advance reproduction of a moving image.

In step S600 in FIG. 9, when standing by for 3D moving image reproduction, it is determined whether or not the parallax adjustment key 94 has been pressed. If it is determined that the parallax adjustment key 94 has been pressed, the process proceeds to step S605 to perform parallax adjustment. This parallax adjustment control is the same as the processing in step S30 to step S60 in FIG. 3. In contrast, if it is determined that the parallax adjustment key 94 has not been pressed, the process proceeds to step S610 to determine whether or not the reproduction key 80 has been pressed.

In step S610, if the reproduction key 80 has not been pressed, the process returns to step S600. In contrast, if the reproduction key 80 has been pressed, the process proceeds to step S615 to execute reproduction of a moving image. At the time of this moving image reproduction, if the parallax adjustment key 94 has been pressed in step S610, 3D moving image reproduction is performed using a parallax amount that has been changed by the parallax adjustment.

Next, in step S620, it is determined whether or not the fast advance key 86 has been pressed. If it is determined that the fast advance key 86 has been pressed, the process proceeds to step S625 to perform fast advance reproduction of the moving image that is currently being reproduced. In contrast, if it is determined that the fast advance key 86 has not been pressed, the process proceeds to step S660 to determine whether or not the moving image has ended.

Further, during the fast advance reproduction in step S625, it is determined in step S630 whether or not the parallax adjustment key 94 has been pressed. If the parallax adjustment key 94 has been pressed, the process proceeds to step S635 to perform parallax adjustment. In the parallax adjustment control in step S635, the screen display on which the fast advance reproduction is being performed is switched to a multi-display on which two images comprising an image for the left eye and an image for the right eye are simultaneously displayed, and the parallax is adjusted in a manner that a parallax amount between the image for the left eye and the image for the right eye becomes a value within a range that enables comfortable stereoscopic viewing.

Next, in step S640, it is determined whether or not the stereoscopic display key 82 has been pressed. If the stereoscopic display key 82 has been pressed, the process returns to step S625 to perform fast advance reproduction. Further, if the stereoscopic display key 82 has not been pressed, the process proceeds to step S645. In step S645, it is determined whether or not a waiting state of the digital stereoscopic camera 1 has continued for a predetermined N seconds. If the waiting state has continued for N seconds, the processing returns to step S625 to perform fast advance reproduction.

In contrast, if N seconds has not yet elapsed since entering the waiting state, the processing advances to step S650. In step S650, it is determined whether or not the reproduction key 80 has been pressed. If the reproduction key 80 has been pressed, the process returns to step S615 to switch from a multi-display to a stereo image display and resume reproduction of the moving image as a stereo image. If the reproduction key 80 has not been pressed, the process returns to step S635 to perform parallax adjustment.

Further, if the parallax adjustment key 94 has not been pressed in step S630, the process proceeds to step S655 to determine whether or not the reproduction key 80 has been pressed. If it is determined that the reproduction key 80 has been pressed, the process returns to step S615. In step S615, the fast advance reproduction is ended and moving image reproduction is resumed. In contrast, if it is determined that the reproduction key 80 has not been pressed, the processing returns to step S625 to continue the fast advance reproduction.

If it is determined in step S620 that the fast advance key 86 has not been pressed, the process proceeds to step S660 to determine whether or not the moving image has ended. If the moving image has not ended, the process returns to step S615 to continue reproduction of the moving image. If the moving image has ended, the digital stereoscopic camera 1 ends reproduction of the moving image.

Thus, according to the present example, parallax adjustment can be performed while performing fast advance reproduction of a moving image. Although the above description relates to fast advancing, it should be understood that it is also possible to perform parallax adjustment during fast return reproduction of a moving image according to a flowchart similar to that illustrated in FIG. 9.

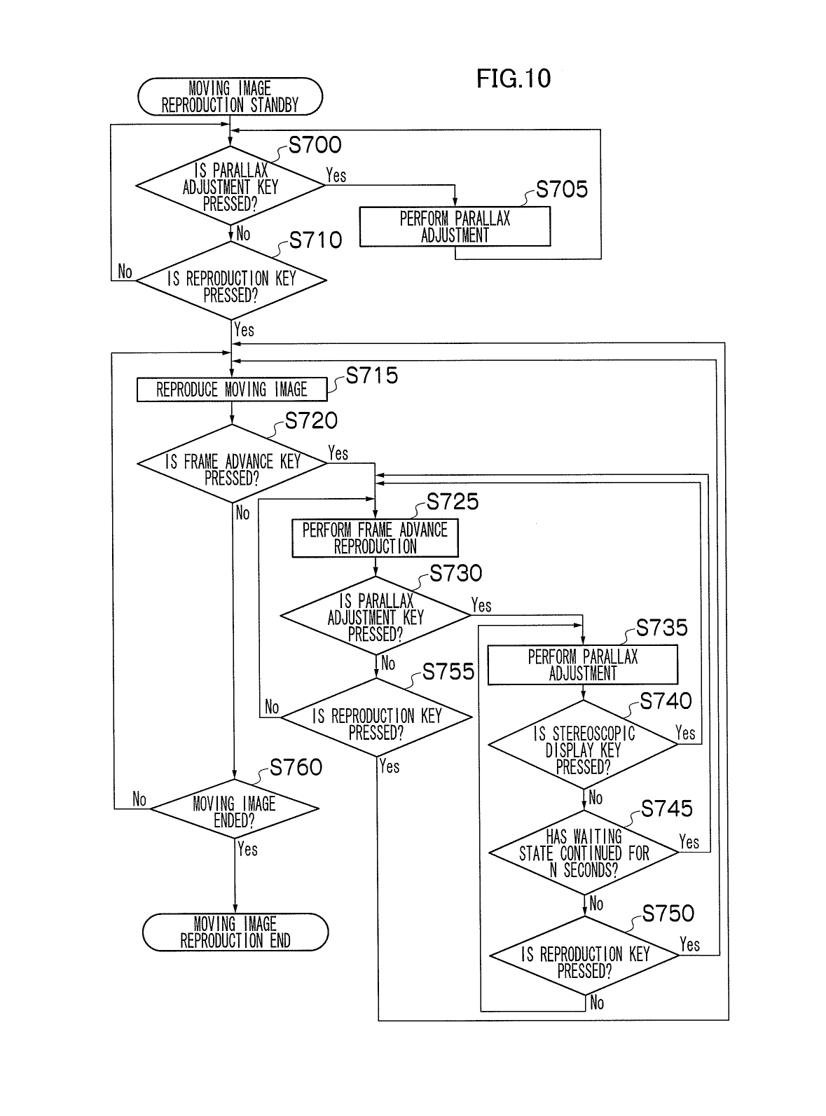

FIG. 10 illustrates a flowchart according to an eighth example of parallax adjustment control.

This example enables parallax adjustment during frame advance reproduction of a moving image.

In step S700 in FIG. 10, when standing by for 3D moving image reproduction, it is determined whether or not the parallax adjustment key 94 has been pressed. If the parallax adjustment key 94 has been pressed, the process proceeds to step S705 to perform parallax adjustment. This parallax adjustment control is the same as the processing in step S30 to step S60 in FIG. 3. In contrast, if the parallax adjustment key 94 has not been pressed, the process proceeds to step S710 to determine whether or not the reproduction key 80 has been pressed.

In step S710, if the reproduction key 80 has not been pressed, the process returns to step S700. In contrast, if the reproduction key 80 has been pressed, the process proceeds to step S715 to execute reproduction of a moving image. At the time of this moving image reproduction, if the parallax adjustment key 94 has been pressed as described above, 3D moving image reproduction is performed using a parallax amount that has been changed by the parallax adjustment.

Next, in step S720, it is determined whether or not the frame advance key 90 has been pressed. If it is determined that the frame advance key 90 has been pressed, the process proceeds to step S725 to perform frame advance reproduction of the moving image that is currently being reproduced. In contrast, if it is determined that the frame advance key 90 has not been pressed, the process proceeds to step S760 to determine whether or not the moving image has ended.

During the frame advance reproduction in step S725, it is determined in step S730 whether or not the parallax adjustment key 94 has been pressed. If the parallax adjustment key 94 has been pressed, the process proceeds to step S735 to perform parallax adjustment. In the parallax adjustment control in step S735, the screen display on which the frame advance reproduction is being performed is switched to a multi-display on which two images comprising an image for the left eye and an image for the right eye are simultaneously displayed, and the parallax is adjusted in a manner that a parallax amount between the image for the left eye and the image for the right eye becomes a value within a range that enables comfortable stereoscopic viewing.

Next, in step S740, it is determined whether or not the stereoscopic display key 82 has been pressed. If the stereoscopic display key 82 has been pressed, the process returns to step S725 to perform frame advance reproduction. If the stereoscopic display key 82 has not been pressed, the process proceeds to step S745 to determine whether or not a waiting state of the digital stereoscopic camera 1 has continued for a predetermined N seconds. If the waiting state has continued for N seconds, the processing returns to step S725 to perform frame advance reproduction.

In contrast, if N seconds has not yet elapsed since entering the waiting state, the processing advances to step S750. In step S750, it is determined whether or not the reproduction key 80 has been pressed. If the reproduction key 80 has been pressed, the process returns to step S715 to switch from a multi-display to a stereo image display and resume reproduction of the moving image as a stereo image. If the reproduction key 80 has not been pressed, the process returns to step S735 to perform parallax adjustment.

If the parallax adjustment key 94 has not been pressed in step S730, the process proceeds to step S755 to determine whether or not the reproduction key 80 has been pressed. If it is determined that the reproduction key 80 has been pressed, the process returns to step S715. In step S715, the frame advance reproduction is ended and moving image reproduction is resumed. In contrast, if the reproduction key 80 has not been pressed, the processing returns to step S725 to continue the frame advance reproduction.

If it is determined in step S720 that the frame advance key 90 has not been pressed, the process proceeds to step S760 to determine whether or not the moving image has ended. If the moving image has not ended, the process returns to step S715 to continue reproduction of the moving image. If the moving image has ended, the digital stereoscopic camera 1 ends reproduction of the moving image.

Thus, according to the present example, parallax adjustment can be performed while performing frame advance reproduction of a moving image. Although the above description relates to frame advance, it should be understood that it is also possible to perform parallax adjustment during frame return reproduction of a moving image according to a flowchart similar to that illustrated in FIG. 10.

Among the examples described above, in the third example and fifth example, after temporarily stopping the moving image reproduction and performing parallax adjustment, the display is switched to the first frame of the moving image so as to reproduce the moving image from the beginning. In the examples other than the third example and fifth example, after performing parallax adjustment, the time point from which to reproduce a moving image is not particularly limited. Accordingly, in each of these examples, a configuration may be adopted so that when resuming reproduction of the moving image after performing parallax adjustment, the moving image reproduction is resumed from the time point at which the moving image was temporarily stopped, or so that the moving image reproduction is resumed from a time point that is a predetermined time period prior to the time point at which the moving image was temporarily stopped. Alternatively, a configuration may be adopted such that the moving image is reproduced from the beginning. Further, a value after the parallax adjustment need not be recorded after reproduction of the moving image, or may be recorded in the relevant moving image file. Alternatively, a configuration may be adopted such that the value after the parallax adjustment is stored in a separate file.

As described above, according to the present embodiment, basically, by pressing only a parallax adjustment key during moving image reproduction and without requiring any other process, it is possible to resume reproduction of a moving image after temporarily stopping the moving image reproduction and performing parallax adjustment, or to perform parallax adjustment while reproducing a moving image. It is thus possible to easily perform parallax adjustment when stereoscopic viewing has become difficult for some reason while reproducing a moving image.

Various examples have been described above in which parallax adjustment is performed while reproducing a moving image as a stereo image. With regard to these examples, when storing a parallax adjustment value after ending reproduction of a moving image, a case in which the parallax adjustment value is stored automatically after ending the moving image reproduction and a case in which the parallax adjustment value is checked by the user and is then stored depending on an instruction by the user may be conceivable. The following methods are available as methods of storing a parallax adjustment value.

First, a method in which a file is created with a different name and tag information relating to parallax adjustment is rewritten therein.

In addition to a data region in which image data for a left eye is compressed and stored and a data region in which image data for a right eye is compressed and stored, an image file in which 3D moving image data is stored, the image file storing 3D moving image data also includes a header region in which header data relating to compression of these pieces of image data is stored. Parallax adjustment information is recorded as tag information in the header region.

Thus, an image file that is identical to the image file in question is created with a different name, and the parallax adjustment information that is recorded as tag information is rewritten in the header region thereof. As a result, the original parallax adjustment information can also be stored at the same time.

Second, a method in which the tag information for a parallax adjustment that is stored in the header region of the above described image file that stores 3D image data is overwritten and updated.

According to this method, it is not necessary to create a new image file with a different name, and it is thereby possible to save the space required for a region to record a file with a different name.

Thus, whichever method is adopted, information on a parallax adjustment that is performed during moving image reproduction can be stored after the reproduction ends, and thus, a value of parallax amount which is adjusted while a user is viewing a moving image can be stored, and parallax adjustment can be omitted when reproducing the moving image at subsequent times thereafter.

Further, according to the foregoing embodiments, the digital stereoscopic camera 1 as a 3D image display apparatus integrally includes the monitor 30 as a display apparatus that displays a moving image, the memories (SDRAM 26, VRAM 28) that store images, and a control apparatus such as the parallax adjustment unit 74 that performs parallax adjustment control.

However, the digital stereoscopic camera 1 need not necessarily integrally include these components, and a configuration may be adopted in which a display apparatus that displays a 3D moving image, a memory (storage apparatus) that stores a moving image, and a control apparatus that performs control such as parallax adjustment are provided as separate bodies.

For example, a configuration may be adopted in which communication is performed between a display such as a TV and a device that stores a moving image. In this case, while a moving image is displayed on the display, a process that controls parallax adjustment or the like can be performed by the device that stores the moving image.

Thus, by separating the display apparatus and the memory and control apparatus in this manner, the presently disclosed subject matter can also be applied to a 3D display apparatus that is not equipped with a parallax adjustment function.

Hereinbefore, the 3D image display apparatus and the 3D image display method of the presently disclosed subject matter have been described in detail. It is to be understood that the presently disclosed subject matter is not limited to the above examples, and it will be apparent that various improvements and modifications can be made to the presently disclosed subject matter without departing from the spirit and scope of the presently disclosed subject matter.

What is claimed is:

1. A 3D (three dimensional) image display apparatus, comprising:
a display device which can display a 3D image for stereoscopic viewing including a plurality of images obtained by taking images of a same object from a plurality of viewing points;
a reproduction key that instructs reproduction of the 3D image for stereoscopic viewing on the display device;
a temporary stop key that instructs to temporarily stop the 3D image for stereoscopic viewing that is being reproduced as a moving image on the display device;
a parallax adjustment key that instructs to perform parallax adjustment on the 3D image for stereoscopic viewing; and
a parallax adjustment control unit that performs parallax adjustment on the 3D image for stereoscopic viewing according to an instruction from the parallax adjustment key, wherein
the parallax adjustment control unit temporarily stops reproduction of the 3D image for stereoscopic viewing that is being reproduced as a moving image on the display device and performs parallax adjustment, and then resumes reproduction of the moving image with a parallax amount after the parallax adjustment reflected on the reproduction.

2. The 3D image display apparatus according to claim 1, further comprising
a storage apparatus that stores image data of the 3D image, wherein
the display device is provided as a separate body from a control apparatus including the parallax adjustment control unit, and the storage apparatus.

3. A 3D image display method, comprising:
when reproducing a 3D moving image for stereoscopic viewing on a display device that can display a 3D image for stereoscopic viewing, performing parallax adjustment upon receiving an input from a parallax adjustment key which instructs to adjust a parallax in a reproduction standby screen of the 3D moving image for stereoscopic viewing of the display device;
reproducing the 3D moving image upon receiving an input from a reproduction key which instructs to reproduce the 3D moving image for stereoscopic viewing on the display device;
temporarily stopping reproduction of the 3D moving image upon receiving an input from a temporary stop key during the reproduction of the 3D moving image;
performing parallax adjustment on the 3D moving image upon receiving an input from the parallax adjustment key while the reproduction is temporarily stopped; and
upon receiving an input from the reproduction key again, resuming reproduction of the moving image with a parallax amount after the parallax adjustment reflected on the reproduction.

4. The 3D image display method according to claim 3, wherein when resuming reproduction of the moving image, the 3D moving image is resumed from a time point at which reproduction of the 3D moving image has been temporarily stopped.

5. The 3D image display method according to claim 3, wherein when resuming reproduction of the moving image, the 3D moving image is resumed from a beginning of the 3D moving image.

6. A 3D image display method, comprising:
when reproducing a 3D moving image for stereoscopic viewing on a display device that can display a 3D image for stereoscopic viewing, performing parallax adjustment upon receiving an input from a parallax adjustment key which instructs to adjust a parallax in a reproduction standby screen of the 3D moving image for stereoscopic viewing of the display device;
reproducing the 3D moving image upon receiving an input from a reproduction key that instructs reproduction of the 3D moving image for stereoscopic viewing on the display device;
temporarily stopping reproduction of the 3D moving image upon receiving an input from the parallax adjustment key during reproduction of the 3D moving image;
performing parallax adjustment on the 3D moving image; and
upon receiving an input from a stereoscopic display key or a reproduction key, or after a predetermined time period of a waiting state without a predetermined operation, resuming reproduction of the moving image with a parallax amount after the parallax adjustment reflected on the reproduction.

7. The 3D image display method according to claim 6, wherein when resuming reproduction of the moving image, the 3D moving image is resumed from a time point at which reproduction of the 3D moving image has been temporarily stopped.

8. The 3D image display method according to claim 6, wherein when resuming reproduction of the moving image, the 3D moving image is resumed from a beginning of the 3D moving image.

9. A 3D image display method, comprising:
when reproducing a 3D moving image for stereoscopic viewing on a display device that can display a 3D image for stereoscopic viewing, performing parallax adjustment upon receiving an input from a parallax adjustment key which instructs to adjust a parallax in a reproduction standby screen of the 3D moving image for stereoscopic viewing of the display device;
reproducing the 3D moving image upon receiving an input from a reproduction key that instructs reproduction of the 3D moving image for stereoscopic viewing on the display device;
during reproduction of the 3D moving image, performing parallax adjustment on the 3D moving image upon receiving an input from the parallax adjustment key; and
upon receiving an input from a stereoscopic display key or a reproduction key, or after a predetermined time period of a waiting state without a predetermined operation, resuming reproduction of the moving image with a parallax amount after the parallax adjustment reflected on the reproduction.

10. The 3D image display method according to claim 3, further comprising
when the parallax adjustment has been performed during reproduction of the 3D moving image, after reproduction of the 3D moving image ends, storing a parallax amount after the parallax adjustment automatically or after confirmation by a user.

11. The 3D image display method according to claim 10, further comprising
when storing the parallax amount after the parallax adjustment, overwriting to update parallax adjustment information that is stored as tag information of a file that stores image data of the 3D moving image.

12. The 3D image display method according to claim 10, further comprising:
when storing the parallax amount after the parallax adjustment, creating a file which has contents identical to a file that stores image data of the 3D moving image and a file name different from the file; and
rewriting parallax adjustment information that is stored as tag information of the created file.
